(19) United States
(12) Patent Application Publication
(10) Pub. No.: US 2014/0057501 A1
(43) Pub. Date: Feb. 27, 2014

(54) ELECTRICAL-MECHANICAL FASTENING DEVICE FOR MOTOR VEHICLES

(71) Applicant: GM GLOBAL TECHNOLOGY OPERATIONS LLC, Detroit, MI (US)

(72) Inventors: David R. Petrucci, Warren, MI (US); Edward D. Moss, Commerce Township, MI (US); Sheng-hong Shih, Troy, MI (US); Louis Meli, Sterling Heights, MI (US); Richard E. MacCleery, Birmingham, MI (US)

(73) Assignee: GM GLOBAL TECHNOLOGY OPERATIONS LLC, Detroit, MI (US)

(21) Appl. No.: 13/838,190

(22) Filed: Mar. 15, 2013

Related U.S. Application Data
(60) Provisional application No. 61/693,380, filed on Aug. 27, 2012.

(51) Int. Cl. H01R 4/02; H01R 43/02

(52) U.S. Cl. CPC H01R 4/029; H01R 43/0214
USPC 439/874; 228/135; 219/117.1

(57) ABSTRACT

An electro-mechanical fastener includes a fastener body having a connection portion materially integrally formed with at least one mounting member. The at least one mounting member has a thickness that is no more than three-times greater than a thickness of a substrate to which the electro-mechanical fastener is joined. The at least one mounting member is configured and disposed to be joined to the substrate through a welded connection.

### CROSS-REFERENCE TO RELATED APPLICATION

This application claims priority of U.S. Provisional Application Ser. No. 61/693,380, filed Aug. 27, 2012, which is incorporated herein by reference in its entirety.

### FIELD OF THE INVENTION

The subject invention relates to the art of motor vehicles and, more particularly, to an electrical-mechanical fastening device for motor vehicles.

### BACKGROUND

Motor vehicles include numerous electrical components that are connected to ground. Many connections to ground are established through a grounding connection to components in the motor vehicle. Grounding connections often take the form of clips, rivenuts and screws threaded into sheet metal panels or other structure employed to connect the electrical component to ground. Often times the connection between the electrical component and the grounding connection, or between the grounding connection and a grounded substrate become loose due to vibration. Loose connections lead to loss of the connection to ground. The loss of the connection to ground may be complete or intermittent. In either case, loss of the connection to ground may lead to improper operation of the associated electrical component. Loose connections are even more prevalent when joining an electrical component to a thin aluminum substrate. Fasteners connected to a thin substrate do not have much material to engage. Also, welding mounting components to thin metal is difficult. Heat produced by the weld may produce holes in the aluminum substrate. Accordingly, it is desirable to provide a fastener that may be used to mount an electrical device to a thin aluminum substrate that provides both a mechanical bond and an electrical link to ground.

### SUMMARY OF THE INVENTION

In one exemplary embodiment, an electro-mechanical fastener includes a fastener body having a connection portion materially integrally formed with at least one mounting member. The at least one mounting member has a thickness that is no more than three-times greater than a thickness of a substrate to which the electro-mechanical fastener is joined. The at least one mounting member is configured and disposed to be joined to the substrate through a welded connection.

In another exemplary embodiment, a motor vehicle includes a substrate having a first thickness, a module connected to the substrate, and one or more electro-mechanical fasteners linking the module and the substrate. The one or more electro-mechanical fasteners includes a fastener body having a connection portion materially integrally formed with at least one mounting member. The at least one mounting member has a second thickness that is no more than three-times greater than the first thickness. The at least one mounting member is joined to the substrate through a welded connection.

In yet another exemplary embodiment, a method of joining a module to a substrate in a motor vehicle includes positioning an electro-mechanical fastener on a substrate having a first thickness in the motor vehicle. The electro-mechanical fastener includes a fastener body having a connection portion materially integrally formed with at least one mounting member having a second thickness that is no more than three times greater than the first thickness. The method also includes welding the at least one mounting member to the substrate, and connecting a module to the mounting member on the electro-mechanical fastener to establish a mechanical bond and an electrical link with the substrate.

The above features and advantages and other features and advantages of the invention are readily apparent from the following detailed description of the invention when taken in connection with the accompanying drawings.

### BRIEF DESCRIPTION OF THE DRAWINGS

Other features, advantages and details appear, by way of example only, in the following detailed description of embodiments, the detailed description referring to the drawings in which:

FIG. 1 is a plan view of a motor vehicle including a module mounted to a substrate through an electro-mechanical fastener in accordance with an exemplary embodiment;

FIG. 2 is a perspective view of the electro-mechanical fastener of FIG. 1;

FIG. 3 is a perspective view of an electro-mechanical fastener in accordance with another aspect of the exemplary embodiment;

FIG. 4 is a perspective view illustrating multiple electro-mechanical fasteners connected to a substrate in accordance with an aspect of the exemplary embodiment; and

FIG. 5 is a perspective view illustrating multiple electro-mechanical fasteners connected to a substrate in accordance with another aspect of the exemplary embodiment.

### DESCRIPTION OF THE EMBODIMENTS

The following description is merely exemplary in nature and is not intended to limit the present disclosure, its application or uses. It should be understood that throughout the drawings, corresponding reference numerals indicate like or corresponding parts and features.

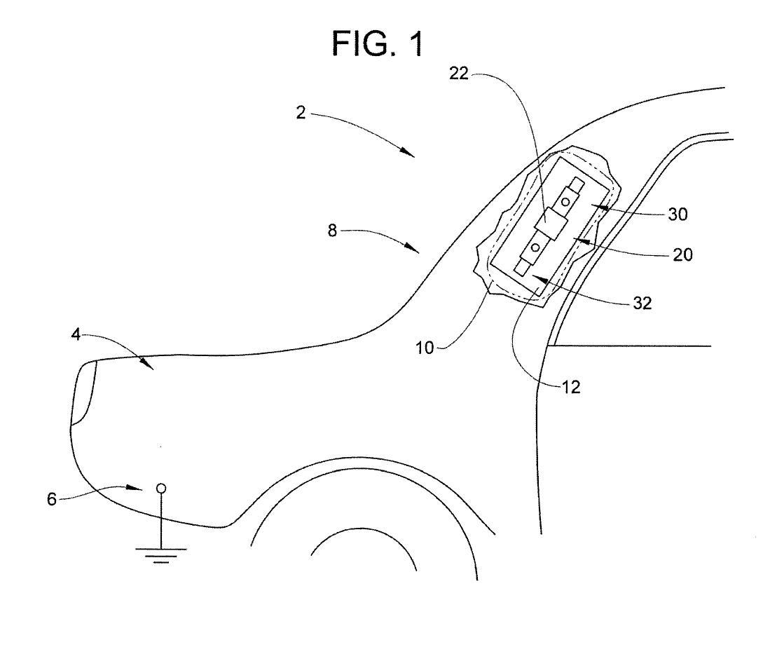

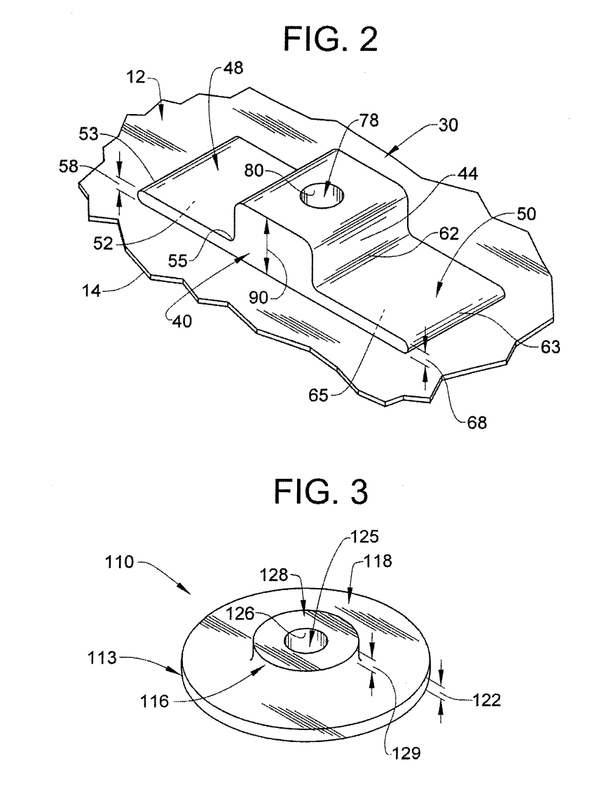

A motor vehicle in accordance with an exemplary embodiment is indicated generally at 2 in FIG. 1. Motor vehicle 2 includes a body 4 that is connected to ground 6. Ground 6 is generally provided through an on-board battery that provides initial starting energy as well as energy to various vehicle components. Body 4 is shown to include a rear pillar 8 that provides support for a vehicle top (not separately labeled) as well as rear window glass (not shown). Rear pillar 8 is formed from a steel panel 10 and a thin inner aluminum panel 12. Inner aluminum panel 12 includes a thickness 14 (FIG. 2) and supports an electrical device 20. In the exemplary embodiment shown, electrical device 20 takes the form of an antenna module 22 secured to inner aluminum panel 12 through a first electro-mechanical fastener 30 and a second electro-mechanical fastener 32.

Reference will now be made to FIG. 2 in describing first electro-mechanical fastener 30 with an understanding that second electro-mechanical fastener 32 includes similar structure. In accordance with an exemplary embodiment, first electro-mechanical fastener 30 includes a fastener body 40 formed from aluminum. Fastener body 40 includes a connection portion 44 materially integrally formed with a first mounting member 48 and a second, opposing mounting member 50. At this point it should be understood that while second mounting member 50 is described as being arranged opposite to first mounting member 48, the particular arrangement of mounting members may vary. First mounting member 48 includes a first end 52 that extends from connection portion 44 to a second, cantilevered end 53 defining a mounting surface 55 having a thickness 58. Similarly, second mounting member 50 includes a first end 62 that extends to a second end 63 through a mounting surface 65 having a thickness 68. Thickness 58 is generally similar to thickness 68. Connection portion 44 includes an opening 78 defined by an inner wall 80. Connection portion 44 is shown to include a thickness 90 that is greater than thicknesses 58 and 68. In this manner, connection portion 44 provides a robust attachment point for electrical device 20.

In accordance with an exemplary embodiment, electro-mechanical fastener 30 is mounted to a substrate which, in the embodiment shown, takes the form of inner aluminum panel 12. Electro-mechanical fastener 30 is welded to inner aluminum panel 12 to establish both a mechanical bond with body 4 and an electrical link with ground 6. In accordance with one aspect of the exemplary embodiment, electro-mechanical fastener 30 is welded using a resistive welding process. Of course, it should be understood, that other welding processes may also be employed. Thicknesses 58 and 68 are sized to facilitate attachment to inner aluminum panel 12. In accordance with one aspect of the exemplary embodiment, thicknesses 58 and 68 are no more than three-times greater than thickness 14. In accordance with another aspect of the exemplary embodiment, thickness 58 and 68 are no more than two-times greater than thickness 14. In accordance with yet another aspect of the exemplary embodiment, thicknesses 58 and 68 are substantially equal to thickness 14. In this manner, first and second mounting members 48 and 50 may quickly dissipate heat applied during welding. Quickly dissipating heat prevents the welding process from damaging inner aluminum panel 12. Once mounted, a mechanical fastener, such as a self tapping screw, is engaged with inner wall 80 to secure electrical device 20 to inner aluminum panel 12.

Reference will now be made to FIG. 3 in describing an electro-mechanical fastener 110 in accordance with another aspect of the exemplary embodiment. Electro-mechanical fastener 110 includes a fastener body 113 having a connection portion 116 materially integrally formed with a mounting member 118. Mounting member 118 includes a thickness 122. Connection portion 116 includes an opening 125 defined by an inner wall 126 that is configured to engage with a mechanical fastener (not shown). Connection portion 116 is also shown to include a thickness 129 that is greater than thickness 122.

In a manner similar to that described above, thickness 122 is sized to facilitate attachment to inner aluminum panel 12. In accordance with one aspect of the exemplary embodiment, thickness 122 is no more than three-times greater than thickness 14. In accordance with another aspect of the exemplary embodiment, thickness 122 is no more than two-times greater than thickness 14. In accordance with yet another aspect of the exemplary embodiment, thickness 122 is substantially equal to thickness 14. In this manner, mounting member 118 may quickly dissipate heat applied during welding.

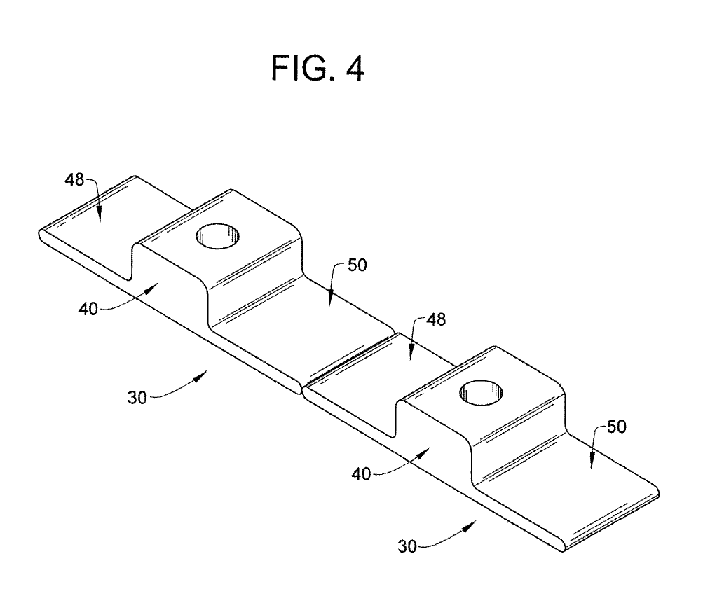

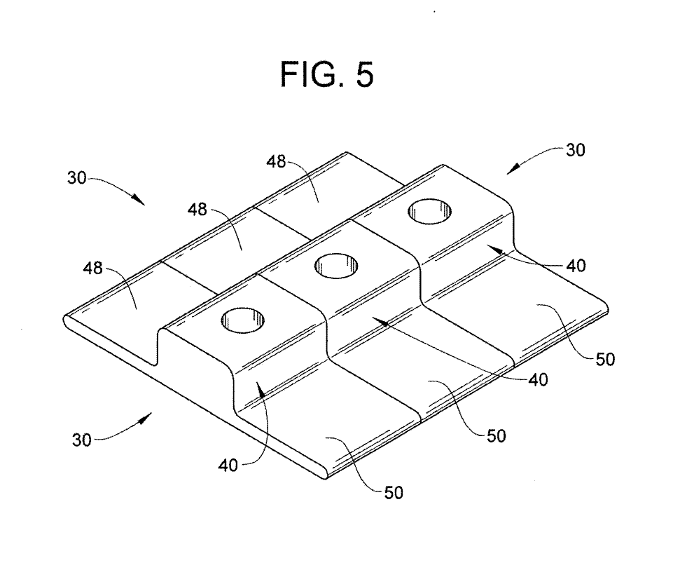

It should be understood that a number of electro-mechanical fasteners may be mounted end to end such as shown in FIG. 4 illustrating a mounting member from one electro-mechanical fastener positioned adjacent to a mounting member from another electro-mechanical fastener with the connection portions being spaced one from another. Of course instead of connecting multiple electro-mechanical fasteners in the manner, a single materially integral electro-mechanical fastener having a similar geometry could also be formed. A number of electro-mechanical fasteners can also be arranged side-by-side as shown in FIG. 5 with connection zones of adjacent electro-mechanical fasteners being directly adjacent one another. Of course instead of connecting multiple electro-mechanical fasteners in the manner, a single materially integral electro-mechanical fastener having a similar geometry could also be formed. Other arrangements of electro-mechanical fasteners or single multi-connection portion electro-mechanical fasteners may also be employed.

At this point, it should be understood that the exemplary embodiments provide a system for establishing an electrical and a mechanical connection between an electrical device and a substrate. The electro-mechanical fastener in accordance with the exemplary embodiments include mounting a structure that is specifically sized to dissipate heat and enable the use of welding operations on thin, lightweight substrates. It should also be understood that while described as providing both an electrical and a mechanical connection, the electro-mechanical fastener may also simply be employed to simply serve as a mechanical support or, alternatively, as simply as an electrical link. Further, being formed from aluminum, the electro-mechanical fastener also acts as a heat sink to dissipate heat from an associated electrical device. It should also be understood that the electro-mechanical fastener can be formed from materials other than aluminum and may be bonded to a substrate formed from a similar material, or a substrate formed from a dissimilar material. In addition, while described as being employed with self-tapping mechanical fasteners, the inner wall of the opening could be threaded such that the electro-mechanical fastener could be employed with non-self-tapping mechanical fasteners.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the application.

What is claimed is:

1. An electro-mechanical fastener comprising:
a fastener body including a connection portion materially integrally formed with at least one mounting member, the at least one mounting member having a thickness that is no more than three-times greater than a thickness of a substrate to which the electro-mechanical fastener is joined, the at least one mounting member being configured and disposed to be joined to the substrate through a welded connection.

2. The electro-mechanical fastener according to claim 1, wherein the at least one mounting member includes a first mounting member extending from the connection portion and a second mounting member extending from the connection portion opposite the first mounting member.

3. The electro-mechanical fastener according to claim 1, wherein the connection portion includes a thickness that is greater than the thickness of the at least one mounting member.

4. The electro-mechanical fastener according to claim 1, wherein the connection portion includes an opening defined by an inner wall configured and disposed to receive a mechanical fastener.

5. The electro-mechanical fastener according to claim 1, wherein the fastener body is formed from aluminum.

6. A motor vehicle comprising:
a substrate having a first thickness;
a module connected to the substrate; and
one or more electro-mechanical fasteners linking the module and the substrate, the one or more electro-mechanical fasteners comprising:
a fastener body including a connection portion materially integrally formed with at least one mounting member, the at least one mounting member having a second thickness that is no more than three-times greater than the first thickness, the at least one mounting member being joined to the substrate through a welded connection.

7. The motor vehicle according to claim 6, wherein the substrate is grounded, the one or more electro-mechanical fasteners establishing both a mechanical bond and an electrical link between the module and the substrate.

8. The motor vehicle according to claim 6, wherein the second thickness is no greater than twice the first thickness.

9. The motor vehicle according to claim 6, wherein the second thickness is substantially equal to the first thickness.

10. The motor vehicle according to claim 6, wherein the one or more electro-mechanical fasteners includes a first electro-mechanical fastener arranged adjacent a second electro-mechanical fastener.

11. The motor vehicle according to claim 10, wherein the at least one connection portion of the first electro-mechanical fastener is positioned directly adjacent to the at least one connection portion of the second electro-mechanical fastener.

12. The motor vehicle according to claim 10, wherein the connection portion of the first electro-mechanical fastener is positioned directly adjacent the connection portion of the second electro-mechanical fastener.

13. The motor vehicle according to claim 6, wherein the at least one mounting member includes a first mounting member extending from the connection portion and a second mounting member extending from the connection portion opposite the first mounting member.

14. The motor vehicle according to claim 6, wherein the connection portion includes an opening defined by an inner wall.

15. The motor vehicle according to claim 6, wherein each of the substrate and the electro-mechanical fastener is formed from aluminum.

16. The motor vehicle according to claim 6, wherein the module comprises an antenna module.

17. A method of joining a module to a substrate in a motor vehicle, the method comprising:
positioning an electro-mechanical fastener on a substrate having a first thickness in the motor vehicle, the electro-mechanical fastener including a fastener body having a connection portion materially integrally formed with at least one mounting member having a second thickness that is no more than three times greater than the first thickness;
welding at least one mounting member to the substrate; and
connecting a module to the mounting member on the electro-mechanical fastener to establish a mechanical bond and an electrical link with the substrate.

18. The method according to claim 17, wherein welding the at least one mounting member to the substrate includes resistance welding the at least one mounting member to the substrate.

19. The method of claim 17, wherein connection a module to the mounting member includes connecting an antenna module to the mounting member.

20. The method of claim 17, wherein welding the at least one mounting member to the substrate includes welding at least one mounting member formed from aluminum to an aluminum substrate.
